(19) United States
(12) Patent Application Publication
(10) Pub. No.: US 2009/0245337 A1
(43) Pub. Date: Oct. 1, 2009

(54) METHOD FOR REDUCING CHANNEL QUALITY INFORMATION IN OFDMA SYSTEMS

(75) Inventors: Vinod Kumar Ramachandran, Bangalore (IN); John M. Harris, Glenview, IL (US); Suresh Kalyanasundaram, Bangalore (IN)

Correspondence Address: MOTOROLA, INC., 1303 EAST ALGONQUIN ROAD, IL01/3RD, SCHAUMBURG, IL, 60196, US

(73) Assignee: MOTOROLA, INC., Schaumburg, IL (US)

(21) Appl. No.: 12/059,499

(22) Filed: Mar. 31, 2008

(51) Int. Cl. H04B 17/00

(52) U.S. Cl. 375/224

(57) ABSTRACT

The present invention is directed to a method that includes determining 302 a distribution of channel conditions across a plurality of physical resource blocks (PRBs) (202-206) and dividing (304) the distribution of channel conditions into a plurality of levels (208-226). The method also includes ordering (306) a ranking of each of the plurality of PRBs according to an instantaneous channel condition for each of the plurality of PRBs and selecting (308) one of the plurality of levels corresponding to an observed condition for each of the ranked plurality of PRBs. In addition, the method includes reporting (310) a mean value of the channel conditions across the plurality of PRBs and a bit value for the selected level for each of the ranked plurality of PRBs.

### FIELD OF THE INVENTION

The present invention relates generally to reducing data required to convey information including channel quality information that is sent in OFDMA systems and, in particular, in ranking channels according to channel conditions or identification numbers and reducing the bits required to convey the rankings.

### BACKGROUND

In certain wireless communication systems that are based on orthogonal frequency division multiple access (OFDMA), system bandwidth is grouped into channels and sub-channels known as physical resource blocks (PRBs.) User equipments report the channel quality information (CQI) on the different PRBs to the network. These CQI reports are generated frequently and are used by the network to select modulation and coding schemes that are used for communicating with the user equipment and the PRBs to allocate to different user equipments. As the reports are frequently provided for multiple PRBs, it places a burden on the uplink signaling load.

According to known methods of reporting CQI in wireless communication systems, such as 3GPP Long Term Evolution (LTE), each user equipment in the system reports the CQI on its best M PRBs, where M is a constant designating the desired number of PRBs in the report. This and other methods reduce the size of messages and uplink signaling load by selecting a given number of PRBs that are acceptable. Accordingly, the signaling load can be reduced by using delta encoding for PRB identifications (IDs) when the CQI is reported in the order of the PRB IDs. For example, if the total number of PRBs is 16, the user equipment reports the ID of the first PRB using a given number of bits. For the second PRB, the user reports the difference between the first and second PRB IDs. Similarly, the third PRB ID can be reported using the difference between the second and third PRB IDs.

CQI reporting for OFDMA system and LTE require reporting over multiple PRBs. The differences provided, however, cannot be lower than a particular value because any of the 16 PRBs can be the best, second best etc. What is needed, therefore, is a method that further reduces the uplink signaling load.

### BRIEF DESCRIPTION OF THE FIGURES

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 is a block diagram of a wireless communication system that utilizes the principles of the present invention.

FIG. 2 is a graph representation of the physical resource blocks ordered in accordance with the principles of the present invention.

FIG. 3 is a flow chart illustrating a method according to the principles of the present invention.

FIG. 4 is a flow chart illustrating another method according to the principles of the present invention.

FIG. 5 is a flow chart illustrating yet another method according to the principles of the present invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION

Before describing in detail embodiments that are in accordance with the present invention, it should be observed that the embodiments reside primarily in combinations of method steps and apparatus components related to an efficient method of reducing the data required to convey the channel quality information for a set of PRBs in OFDMA systems. Accordingly, the apparatus components and method steps have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

In this document, relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

It will be appreciated that embodiments of the invention described herein may be comprised of one or more conventional processors and unique stored program instructions that control the one or more processors to implement, in conjunction with certain non-processor circuits, some, most, or all of the functions of an efficient method of reducing the data required to convey the channel quality information for a set of PRBs in OFDMA systems described herein. The non-processor circuits may include, but are not limited to, a radio receiver, a radio transmitter, signal drivers, clock circuits, power source circuits, and user input devices. As such, these functions may be interpreted as steps of the method to perform an efficient method of reducing the data required to convey the channel quality information for a set of PRBs in OFDMA systems. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Thus, methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The present invention is directed to a method that includes determining a distribution of channel conditions across a plurality of PRBs and in an example for each of the best to worst PRBs. The best PRB is the PRB that experiences the highest signal to noise ratio and the worst PRB is the PRB that experiences the least signal to noise ratio. The distribution of channel conditions can be determined using order statistics. The method includes dividing the distribution of channel conditions into a plurality of levels, which can be modulation and coding scheme levels. The method also includes ordering the PRBs according to a ranking of the instantaneous channel conditions for each of the plurality of PRBs. In an embodiment the first ranking can correspond to the best channel conditions and the subsequent rankings are in a successive order of channel conditions. The method continues by selecting an MCS level that best represents the current channel condition of the PRB from the plurality of MCS levels representative of the distribution of the channel conditions for a given PRB.

In addition, the method includes reporting a mean value of the channel conditions across all PRBs and a representation of the range, which can include a bit value for the selected level for each of the ranked PRBs. In an embodiment, one of the levels is represented by a minimum number of bits required to represent that level. The method also includes reducing the number of bits required to report a successive rank. For example, if the total number of levels spanned by the distribution of the best PRB is 8 and the first rank was level 4, it is represented by 3 bits and the next rank must be level 4 or less and can be represented using 2 bits. In other words, the representation of the ranking includes a minimum number of bits for each of the rankings.

In an embodiment of the method, the channel conditions are conveyed by channel quality information representative of the signal to noise ratio of the plurality of channels, and the MCS levels are an equal division of the channel conditions. Moreover, the representation of the range comprises one of the designated levels of the channel conditions.

In another embodiment of the principles described, the method includes determining a distribution of channel conditions for each of the best to worst PRBs, which can be achieved by using order statistics. In addition, the method includes dividing the distribution of channel conditions into a plurality of MCS levels and ranking each of the plurality of PRBs or channels according to the instantaneous channel conditions for the PRBs. A level of the channel conditions can be selected from the plurality of levels representative of the distribution of the channel conditions for a PRB and based on the observed channel condition for the ranked PRBs. The method includes reporting the identity of the best PRB from the observed rankings of channel conditions and a minimum number of bits to report the CQI for the selected first rank using the mean value of the channel conditions. The number of bits for the selected first rank is equal to the ceil(log₂ N), where N is the number of MCS levels within which most of the probability of the best PRB lies, given the mean value of the channel conditions across all PRBs. In addition the method includes reporting the identity of the PRB with a subsequent or successive rank to the first rank from the rankings of channel conditions and the observed CQI on the subsequent or successive ranked PRB based on the minimum number of bits for the selected level for the first rank.

In another embodiment, the method includes determining a distribution of channel conditions for each of the best to worst PRBs; dividing the distribution of channel conditions into a plurality of MCS levels and ranking each of the plurality of PRBs or channels according to the instantaneous channel conditions for the PRBs. A level of the channel conditions can be selected from the plurality of levels representative of the distribution of the channel conditions for a PRB and based on the observed channel condition for the ranked PRBs. The channels are selected such that the selected channels have a higher CQI than the ones that are not selected (i.e., top M channels are selected based on the observed instantaneous channel conditions), and then ordered according to the PRBs IDs. The method continues with reporting the channel identity of the first rank from the rankings of identifications of the channels using a minimum number of bits for the identification of the channel and reporting the value of the channel condition observed on that channel, and reporting the channel identity of the subsequent ranked channel from the rankings of identification of channels using a minimum number of bits for the identification of the channel based on the first identification.

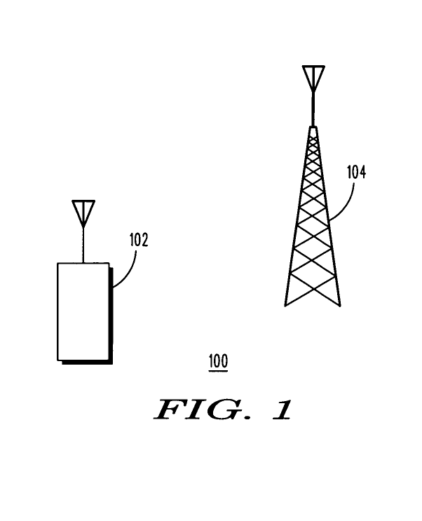

Turning to FIG. 1, a communication system 100 is shown that includes user equipment 102 and nodes 104. The communication system 100 can be any of the known and developing wireless communication systems and networks including LTE and other networks based on OFDMA principles and concepts. The principles described also apply to other technologies for wireless communication systems. As is known, OFDMA provides multiple channels and sub-channels also known as physical resource blocks (PRBs) between the user equipment 102 and the nodes 104 and those channels and sub-channels are used for network messages and data. It is an objective to reduce the amount of network messages, e.g. overhead, to therefore provide more channels or PRBs for user data. Various measurements are made to determine the status and quality of the channels, sub-channels and PRBs. These measurements include the signal to noise ratios (SNR).

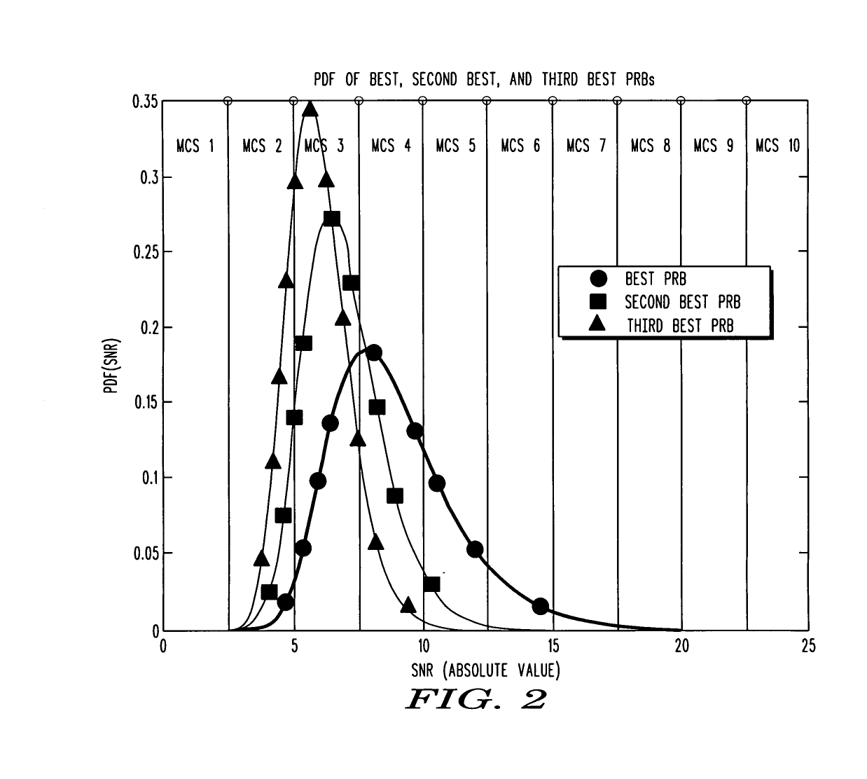

The probability distribution function of the SNR of a particular PRB is known and can be assumed to be independent and identically distributed over the various PRBs. For example, the distribution of the SNR is exponential for a user on a given PRB when the channel fading follows a Rayleigh distribution. The mean of the exponential distribution will not be known however, and is conveyed as part of the channel quality reporting. Turning to FIG. 2, it is shown that it is possible to compute the probability distribution functions of best PRB 202, second best PRB 204 and third best PRB 206 using known order statistics methods.

In addition, FIG. 2 illustrates that the distribution of SNR data across the channel is divided into the various levels or modulation and coding schemes (MCS) 208-226 that are available for each of these shown PRBs 202-206. It is understood that for OFDMA systems additional MCSs are available for the PRBs. As shown, the SNRs can be measured for given dB increments, and the MCSs can be assigned to ranges of SNR per MCS. The entire SNR range can be quantized into the multiple MCS levels shown in FIG. 2. In an embodiment, the number of MCS levels can be limited to 10 equal ranges, as shown. In an embodiment, the OFDMA network uses CQI information to choose the optimal MCS, and the allocation of PRBs to users. Based on limiting the SNR range for each MCS and limiting the number of MCS levels, user equipment 102 can report only the MCS level corresponding to each of its top M number of PRBs as part of the CQI report.

The MCSs are chosen to represent given SNR values of the CQI reports and to simplify the reporting of the CQI report. In an embodiment, the signaling can be further reduced when the user equipment reports the CQI of its best PRB by restricting the candidate MCS levels to those that are spanned by the probability distribution function of that best PRB. The probability distribution function of the best PRB is known based on the knowledge of the mean MCS level across all PRBs. In other words, the user equipment need only report one MCS level for its best PRB among the number of MCS levels spanned by the probability distribution function of the best PRB rather than among all of the MCS levels. For example, one MCS level among the MCS level range 2-8 can be used to represent the SNR range of the best PRB 202 and one MCS level among the MCS level range 2-7 can be used to represent the SNR range of the second PRB 204. The CQI report will include the identities of the top M PRBs in rank order, and the MCS level for each of the ranked PRBs.

As shown in FIG. 2, the user equipment only has to report one of the 7 candidate MCS levels for the best PRB instead of the available 10 ranked levels. The reported one level can be selected based on an observed channel condition for each of the ranked PRBs. By limiting the number of levels to those necessary, the number of bits needed is reduced from 4 to 3. For the following second best PRBs, the number of bits can be further reduced according to the span of the MCS levels corresponding to their probability distribution functions. For the third best PRB, for example, only 2 bits are needed as only MCS levels 2-5 are the candidates. This is true because of the distribution of channel conditions of the third best PRB reduces the range of possible MCS levels, given the mean MCS level across all PRBs. In view of the foregoing, the network 100 will be able to determine the absolute MCS levels as it knows the probability distribution function of the best, second best, third best, etc. PRBs based on the network's 100 use of order statistics and the mean MCS level across all PRBs to determine the relevant probability distribution functions. A further optimization is possible by using the exact CQI value on the previously ranked PRB, the network 100 can glean additional information of a specific PRB.

In an embodiment, more optimization is available based on the knowledge that a PRB is assigned a specific MCS level for the designated SNR range. In other words, a ranked PRB is represented by a specific, or one, level within the range of the SNR values for a particularly ranked PRB, which is based on the observed channel conditions for the ranked PRB. This further removes the availability of all MCS levels that are higher than that MCS level for a lesser or subsequently ranked PRB. To the extent that the MCS levels overlap for different PRBs, the knowledge that a specific MCS level is being used by a higher ranked PRB limits the availability of all MCS levels that are higher than that MCS for the successively or subsequently ranked PRBs.

For example, and still referring to FIG. 2, the user equipment can report the MCS level 3 for its best PRB 202 as it is within the range of MCS 2 to MCS 8 for the best ranked PRBs. This automatically implies that a lesser or equal MCS level, i.e. MCS 2 or MCS 3, must be used by the second best PRB 204. Thus the MCS level of a subsequent ranked PRB can be conveyed using 1 bit in the CQI message. Further, if the second best MCS is MCS 2, there will be no need for any bits to convey that the third ranked PRB 206 is MCS 2.

It is noted that the above description has been limited to the SNR distribution of a single user. It is possible that different users in a cell have different distributions and values. That results in a large SNR range. Accordingly, the probability distribution functions of the ranked PRBs will be different for different users. Moreover, for the same user the mean SNR or MCS level across all PRBs may vary with time. This may require that user equipment report the mean SNR or MCS level when it changes so that network 100 can use appropriate probability distribution functions to decode absolute MCS levels.

By using the probability distribution functions for the ranked PRBs, it has been shown that the number of MCS levels can be restricted. In another form of CQI reporting, a fixed number of bits per PRB can improve the granularity of the CQI reports. The restricted SNR ranges of the various ranked MCSs and the associated PRBs can be shown using the number of available bits. Instead of using a given number of bits to designate PRBs and associated MCS levels where many levels are not used by the PRB, the bits can be associated with the known MCS levels for that ranked probability function. For example, if 4 bits are being used to represent the MCS levels for a given ranked PRB, those 4 bits can represent 16 levels. As shown in FIG. 2 for the first ranked PRB, the probability distribution function spans 7 MCS levels. Thus, the 4 bits can represent a finer granular region of the 7 MCS levels instead of representing all the various available levels. While the number of MCS levels spanned by the highest ranked PRB has not changed, the network 100 will be able to obtain fine granular CQI for the user equipment 102.

From FIG. 2 for example, MCS level 4 corresponds to an SNR range of 7.5 to 10 dB. Because of the fine granular reporting provided by restricting the bits to known MCS levels, the network 100 may be able to distinguish between one user equipment in the range of 7.5 to 8.36 dB from another in the range of 8.36 to 9.3 dB instead of having information only denoting that the user equipment is in the given wide SNR range. This additional information can subsequently be used by the network to determine a better allocation of PRBs to users.

The above description has shown uses when the complete PRB ID specified for each of the ranked PRBs is used in reporting. According to the principles described, the signaling load can be also reduced by reporting the CQI in the ranked order of the PRB IDs and then applying the principles of encoding to those PRB IDs. This is different than reporting the difference in PRB IDs as part of the ranking. Rather, the principles of the invention lessen overhead by using information regarding higher ranked IDS to reduce the number of bits for successively or subsequently ranked PRBs. In this embodiment, CQI values need to be reported in full i.e., one MCS level among all possible MCS levels need to be specified for each PRB. For a given number of bits used to represent the PRB IDs, as the rank is decreased the number of bits needed to represent that ranked PRB ID is also reduced. For example, the highest rank PRB can use all of the bits while a lower ranked PRB need only use the number of bits required for its rank based on the information already conveyed for a higher ranked PRB.

If the ranked PRB IDs are 8, 7 and 5, at least 4 bits are needed to represent the highest ranked PRB ID 8 (assuming a total of 16 PRBs are present in the system), i.e. bit representation 1000, while three bits can be used to represent the next highest ranked PRB ID of 7, i.e. bit representation 111. If the highest ranked PRB is represented by the bit combination of 1001, the next value can be four bits long. If the first three bits of the next highest ranked PRB is 1000 then the subsequent value can also be three bits long because, if the three most significant bits of the next four digit value is 100, the fourth bit must be a 0, and therefore the fourth bit does not need to be sent. In the case where the first PRB ID is represented by 100100 (assuming a total of 64 PRBs in the system,) the next subsequent ranked PRB will be represented by 6 bits. But if the first three bits of the PRB ID is represented by 100, the fourth bit must be a 0 as 1 was previously used and therefore does not need to be sent and only the next 2 bits must be sent. The number of bits is therefore reduced to 5. In this way, knowledge concerning a higher ranked ID can reduce the number of bits needed to represent a subsequent ID.

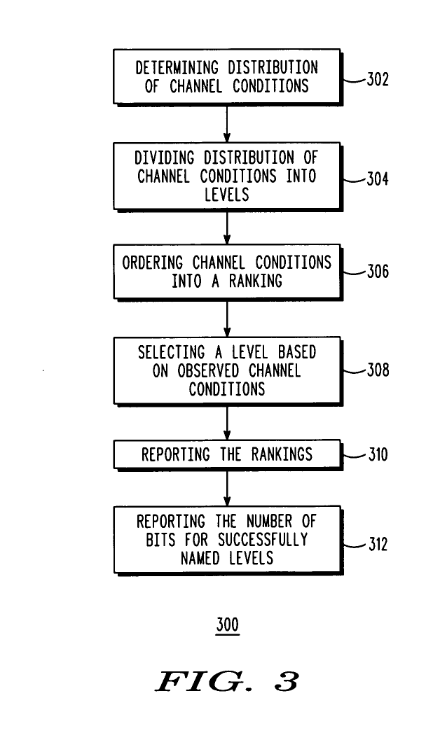

Turning to FIG. 3, a flow chart 300 of a method that reduces channel quality information signaling load in OFDMA systems is shown. According to the method, a distribution of channel conditions across a plurality of PRBs is determined 302. The distribution of channel conditions can be for each of the best to worst PRBs for a given user equipment and can be determined using mean channel conditions across the plurality of PRBs and a range of channel conditions. In an embodiment, order statistics are used to determine the distribution. The spectrum of SNR values over the distribution of channel conditions can be divided 304 into a plurality of levels, which correspond to a plurality of modulation and coding schemes. In an embodiment, the division of levels is such that the range of SNR values for each level is equal. Moreover, any number of levels can be used and in an example 10 levels are provided. Thus, in an embodiment, the distribution of channel conditions for a plurality of channels for a given user can be shown to span over a number of levels which is generally less than the total number of levels provided.

The PRBs are then ordered 306 according to a ranking of the instantaneous channel conditions for each of the plurality of PRBs. As seen in FIG. 2, the ranking is across the various levels and based on the order statistics, each successive or subsequent ranking uses a reduced or smaller range of levels, or SNR values. Moreover, each successive ranking moves towards reduced SNR values or, as shown, moves in a given direction, e.g. to the left, of the graph. In an embodiment, the first ranking can correspond to the best channel conditions or best PRB 202 and the subsequent rankings are in a successive order of channel conditions for second best PRB 204, third best PRB 206 etc. The method continues by selecting 308 one of a range and a level that corresponds to the observed channel condition on that ranked PRB from the plurality of levels representative of the distribution of the channel conditions for PRB with the given rank.

In addition, the method includes reporting 310 the rankings of channel conditions. In an embodiment, rankings are reported by using a mean value of the channel conditions as a representation of the channel conditions as well as an identification for the reported PRB. The representation includes one of the designated levels of the channel conditions. In an embodiment, one of the levels is represented by a minimum number of bits required to represent that level based on the probability distribution function of the channel with a given rank. The method also includes reducing 312 the number of bits required to report a successive rank. For example, if the first rank was level 4, which is represented by 3 bits based on the knowledge of the span of MCS levels for the highest ranked channel, the next rank must be level 4 or less and can be represented using 2 bits. In other words, the representation of the ranking includes a minimum number of bits for each of the rankings. Therefore, the number of bits required to report the successively or subsequently ranked PRBs is based on the number of bits and the actual bits required to report the higher ranked PRB. Using the mean value and the known distribution of channel condition as well as the reported channel conditions, the network can determine the CQI information from the user equipment.

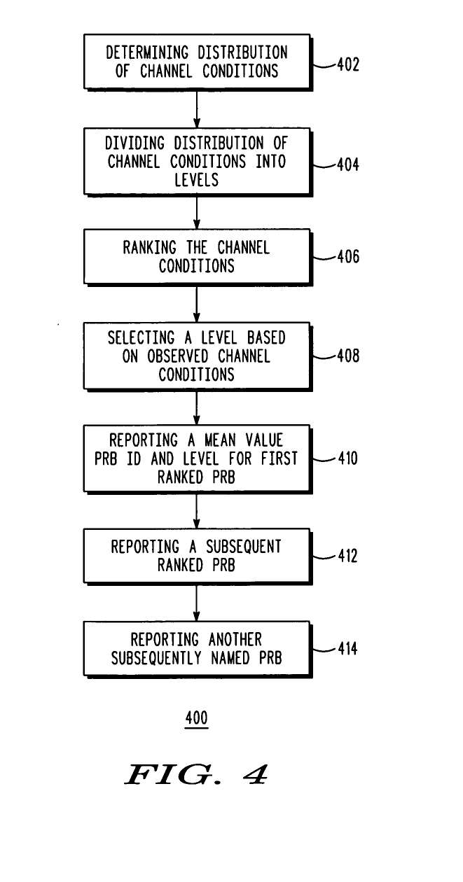

FIG. 4 illustrates a flow chart 400 of another embodiment of the present invention of a method that reduces channel quality information signaling load in OFDMA systems. The method begins by determining 402 a distribution of channel conditions for a plurality of PRBs and for example for each of the best to worst PRBs. The distribution of channel conditions can be achieved by using order statistics. The spectrum of SNR values over the distribution of channel conditions can be divided 404 into a plurality of levels or MCS. In an embodiment, the distribution of channel conditions for a plurality of channels for a given user can be shown to be over a number of levels which is generally less than the total number of levels provided. The PRBs are then ranked 406 according to the instantaneous channel conditions for each of the PRBs

A level of the channel conditions can be selected 408 from the plurality of levels representative of the distribution of the channel conditions for a user. The method includes reporting 410 a mean value of the channel conditions, the PRB ID of the first ranked PRB from the rankings of channel conditions and the selected level corresponding to the observed SNR value on that PRB. The selected level is reported using a minimum number of bits for the selected first rank. In an embodiment, one of the levels within the range of levels of the first rank is used to represent that first rank. For example from FIG. 2, MCS level 5 can be used to represent the first rank 202, which is depicted using 3 bits because the span of MCS levels for the highest ranked PRB is known to be in the range of MCS 2-7. In addition the method includes reporting 412 a subsequent rank of the first rank, e.g. the second rank, from the rankings of channel conditions, using a bit representation based on the minimum number of bits for the selected level for the first rank where the number of bits for the successively or subsequently ranked PRB is less than the number of bits used to represent the first ranked PRB. Continuing the example from FIG. 2, MCS level 3 can be used to represent the second rank 204, which requires 2 bits because the probability distribution function of the second ranked PRB only spans the MCS levels 2-5. Moreover, the method can include reporting 414 another subsequent rank, i.e. third rank 206, based on the reported MCS levels for the first rank and for the subsequent rank of the first rank.

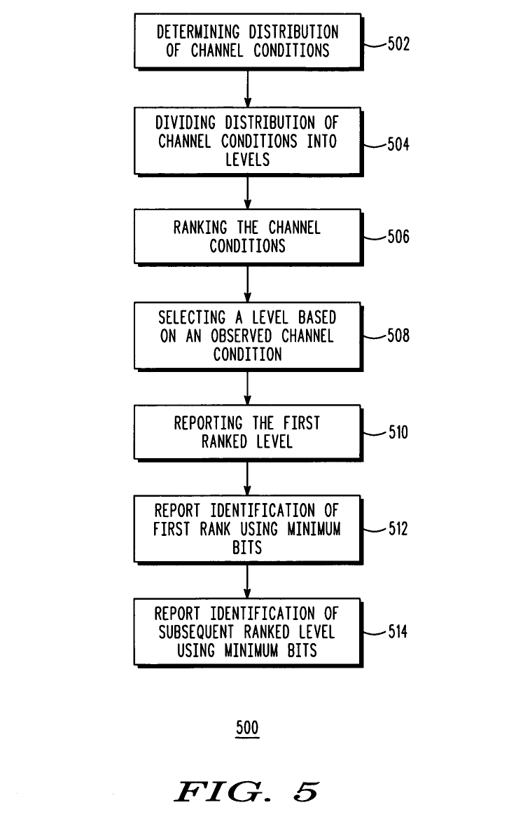

FIG. 5 illustrates a flow chart 500 of another embodiment of the present invention of a method that reduces channel quality information signaling load in OFDMA systems. The method begins by determining 502 a distribution of channel conditions for a plurality of PRBs. The spectrum of SNR values over the distribution of channel conditions can be divided 504 into a plurality of levels. The PRBs are then ranked 506 according to the instantaneous channel conditions for each of the PRBs. A level of the channel conditions can be selected 508 from the plurality of levels representative of the distribution of the channel conditions for a user. The method continues with reporting 510 the selected level for the first ranked PRB. In addition, the channel identification of the first rank from the rankings of identifications of the channels is reported 512 using a minimum number of bits for the identification of the channel. The value of the channel condition observed on that channel can also be reported. Moreover, channel identification of the subsequent ranked channel from the rankings of identification of channels is reported 514 using a minimum number of bits for the identification of the channel based on the first identification.

On the basis of the above description and method, the benefits of using order statistics of the probability distribution function for selecting MCSs can be shown. A number of bits are used within OFDMA to convey mean SNR for PRBs. In an embodiment, 5 bits can be used to designate the mean SNR of the PRBs. It has been shown that the dynamic range of the best PRB (PRB with the highest SNR) based on the range of SNR values can be reduced to 7 levels. In addition, it has been shown that the dynamic range of the second best PRBs based on the range of SNR values can be reduced to only 4 levels. As the rank of PRB is reduced the number of levels is also reduced and is not any higher than a higher ranked PRB. As can be appreciated, there are a corresponding number of bits required to convey the number of levels. Moreover, the number of bits is reduced as the rank is reduced. In other words, fewer bits are required for subsequent ranked levels. Based on the demonstrated dynamic range for the best and second best, etc., ranges, 3 bits is generally required to convey the 7 levels of the best ranked channel, 2 bits is generally required to convey the second best ranked channel as well as for each subsequently ranked channel or PRB.

Thus, it can be shown that the overhead is reduced by using the order statistics of the probability distribution function. When the PRB index requires 7 bits, the total number of bits needed for M best PRBs is shown by the equation (5+(3+7)+(2+7)(M−1)). In addition, the second best PRB is encoded based on the observed value of the previous ranked PRB such that the number of bits for the second best PRB can be approximated as 0.5*2+0.5*1=1.5 bits. Similarly for the third and subsequent channels the number of bits can be approximated to be 1.5 bits. Referring back to FIG. 2 where M is 10, i.e. 10 MCS levels, the number of bits is equal to 92. Without the ranking and using order statistics as described the 7 bits for the PRB index and 4 bits for the level, i.e. 11 bits, is required for each ranked channel so that 110 bits are needed to convey the same information. Thus, the described principles provide a 16.4% reduction in the CQI overhead per channel. This reduction can be increased because of the dynamic range of PRBs is lowered for more MCS levels.

In the foregoing specification, specific embodiments of the present invention have been described. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

We claim:

1. A method comprising
determining a distribution of channel conditions across a plurality of physical resource blocks (PRBs);
dividing the distribution of channel conditions into a plurality of levels;
ordering a ranking of each of the plurality of PRBs according to an instantaneous channel condition for each of the plurality of PRBs;
selecting one of the plurality of levels corresponding to an observed condition for each of the ranked plurality of PRBs, and
reporting a mean value of the channel conditions across the plurality of PRBs and a bit value for the selected level for each of the ranked plurality of PRBs.

2. The method of claim 1 wherein the ranking of each of the plurality of PRBs ranks each of the plurality of PRBs from best PRB to worst PRB.

3. The method of claim 1 wherein report the ranking of each of the plurality of PRBs further comprising reporting an identification for each of the ranked plurality of PRBs.

4. The method of claim 1 wherein reporting the ranking of the plurality of PRBs further comprising reducing a number of bits in the bit value for each successive rank in the rank of the plurality of PRBs.

5. The method of claim 4 wherein reducing a number of bits further comprising reducing a number of bits according to the reported bit value for a higher ranked PRB.

6. The method of claim 1 wherein determining a distribution of channel conditions being according to mean channel conditions across the plurality of PRBs.

7. The method of claim 1 wherein the distribution of channel conditions being across a range of channel conditions.

8. The method of claim 1 wherein channel conditions comprise channel quality information representative of a signal to noise ratio of the plurality PRBs.

9. A method comprising:
determining a distribution of channel conditions across a plurality of physical resource blocks (PRBs);
dividing the distribution of channel conditions into a plurality of levels;
ranking each of the plurality of PRBs according to an instantaneous channel condition for each of the plurality of PRBs;
selecting one of the plurality of levels corresponding to an observed channel condition for each of the ranked plurality of PRBs;
reporting a mean value of the channel conditions, the selected level of a first ranked PRB using a minimum number of bits to represent the selected level and the selected level a second ranked PRB using an minimum number of bits to represent the selected level wherein the minimum number of bits to represent the selected level of the second ranked PRB being less than the minimum number of bits to represent the selected level of the first ranked PRB.

10. The method of claim 9 wherein the ranking of each of the plurality of PRBs ranks each of the plurality of PRBs from best PRB to worst PRB.

11. The method of claim 10 wherein the first ranked PRB is the best PRB and the second ranked PRB is a successively ranked PRB to the best PRB.

12. The method of claim 9 wherein report the ranking of each of the plurality of PRBs further comprising reporting an identification for each of the ranked plurality of PRBs.

13. The method of claim 9 wherein determining a distribution of channel conditions being according to mean channel conditions across the plurality of PRBs.

14. The method of claim 9 wherein channel conditions comprise channel quality information representative of a signal to noise ratio of the plurality PRBs.

15. A method comprising:
determining a distribution of channel conditions across a plurality of physical resource blocks (PRBs);
dividing the distribution of channel condition into a plurality of levels;
ranking each of the plurality of PRBs according to an instantaneous channel condition for each of the plurality of PRBs;
selecting one of the plurality of levels corresponding to an observed channel condition for each of the ranked plurality of PRBs;
reporting a first rank of the ranked plurality of PRBs using a bit representation of the selected level and an identification of the first rank of the ranked plurality of PRBs and a second rank of the ranked plurality of PRBs using a bit representation of the selected rank and identification of the second rank of the ranked plurality of PRBs wherein the bit representation of the identification of the second rank is based on the bit representation of the first rank of the ranked plurality of PRBs.

16. The method of claim 15 wherein the ranking of each of the plurality of PRBs ranks each of the plurality of PRBs from best PRB to worst PRB.

17. The method of claim 16 wherein the first ranked PRB is the best PRB and the second ranked PRB is a successively ranked PRB to the best PRB.

18. The method of claim 15 wherein report the ranking of each of the plurality of PRBs further comprising reporting an identification for each of the ranked plurality of PRBs.

19. The method of claim 15 wherein determining a distribution of channel conditions being according to mean channel conditions across the plurality of PRBs.

20. The method of claim 15 wherein channel conditions comprise channel quality information representative of a signal to noise ratio of the plurality PRBs.
